(19) United States
(12) Patent Application Publication
(10) Pub. No.: US 2010/0032920 A1
(43) Pub. Date: Feb. 11, 2010

(54) LOWER ARM ASSEMBLY FOR SUSPENSION SYSTEM

(75) Inventor: In Cheol HONG, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/469,363

(22) Filed: May 20, 2009

(30) Foreign Application Priority Data
Aug. 8, 2008 (KR) 10-2008-0078123

(51) Int. Cl. B60G 7/02

(52) U.S. Cl. 280/124.109

(57) ABSTRACT

A lower arm assembly for a suspension system may include a lower arm member, and/or a stabilizer bar mounting rod supported by the lower arm member, wherein one end portion of the stabilizer bar mounting rod is pivotally coupled to a shock absorber and the other end thereof is fixedly connected to a connecting link.

### CROSS-REFERENCE TO RELATED APPLICATION

The present invention claims priority to Korean Patent Application No. 10-2008-0078123 filed on Aug. 8, 2008, the entire contents of which are incorporated herein for all purposes by this reference.

### BACKGROUND OF THE INVENTION

1. Field of the Invention

The present invention relates to a lower arm assembly for a suspension system. More particularly, the present invention relates to a lower arm assembly for a suspension system that may mount a shock absorber and a stabilizer bar without a mounting bracket.

2. Description of Related Art

Basically, a suspension system refers to the apparatus including front and rear springs to suspend a vehicle's frame and body, or unitized body, as well as the engine and power train, disposed above the wheels.

Designs for a combining structure of a suspension system are also under constant investigation for satisfying stability, comfortability, handling, and so on. In a conventional suspension system, as shown in FIG. 4, a knuckle 102 provided with a tire 100 through a wheel (not shown) is connected with a vehicle body 106 by interposing a lower arm 104 below the knuckle 102.

A strut assembly 112 that is integrally formed by a coil spring 110 and a shock absorber (not shown) is mounted to an upper portion of the lower arm 104 through a mounting bracket 108, and an upper portion of the strut assembly 112 is suspendedly connected with a vehicle body (not shown) by interposing an insulator 114.

One end of a stabilizer bar 116 is connected with one side of the lower arm 104 by a connecting link 118, and a mounting pin 120, as shown in FIG. 5, is disposed to the lower arm 104 for connecting the connecting link 118.

Vibration and impact transmitted from the road may be reduced in the strut assembly 112 so that the vibration and impact transmitted to the vehicle body can be minimized.

However, the conventional lower arm needs a mounting bracket for mounting the shock absorber and a mounting pin for connecting with the connecting link so that rigidity of the lower arm can be deteriorated.

Also, the total size and weight of the lower arm is increased for mounting the mounting bracket and the mounting pin.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a lower arm assembly for a suspension system of which weight may be reduced and rigidity may be increased.

In an aspect of the present invention, a lower arm assembly for a suspension system, may include a lower arm member, and/or a stabilizer bar mounting rod supported by the lower arm member, wherein one end portion of the stabilizer bar mounting rod is pivotally coupled to a shock absorber and the other end thereof is fixedly connected to a connecting link.

The lower arm member may include a first mounting rod hole to receive the stabilizer bar mounting rod in a traverse direction of the lower arm member therethrough.

A shock absorber mounting portion may be coupled to one lateral side of the lower arm member and mounts the one end portion of the shock absorber between the lower arm member and the shock absorber mounting portion.

A second mounting hole may be formed to the shock absorber mounting portion to receive the one end portion of the stabilizer bar mounting rod.

The shock absorber mounting portion may be monolithically formed to the lower arm member.

A receiving hole may be formed between the shock absorber mounting portion and the lower arm member for receiving a lower portion of the shock absorber therein.

The lower portion of the shock absorber may include a shock absorber connector to pivotally support the shock absorber.

The connecting link may be mounted onto the other lateral side of the lower arm member.

In another aspect of the present invention, the lower arm assembly may further include a supporting member that is disposed within the lower arm member and includes a contact portion and a supporting portion, wherein the contact portion supports an inner upper surface of the lower arm member and the supporting portion is supported by an inner lower surface of the lower arm member wherein a third mounting rod hole is formed to the supporting member and the stabilizer bar mounting rod is inserted into the third mounting rod hole.

In further another aspect of the present invention, the lower arm member may include an upper arm plate and a lower arm plate that is integrally connected with the upper arm plate and a supporting member that is disposed within the lower arm member and includes a contact portion and a supporting portion, wherein the contact portion supports the upper arm plate and the supporting portion is supported by the lower arm plate.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view including an exemplary lower arm assembly for a suspension system according to the present invention.

FIG. 2 is a perspective view of an exemplary lower arm assembly for a suspension system according to the present invention.

FIG. 3 is an exploded perspective view of an exemplary lower arm assembly according to the present invention.

FIG. 4 is a perspective view including a conventional lower arm assembly for a suspension system.

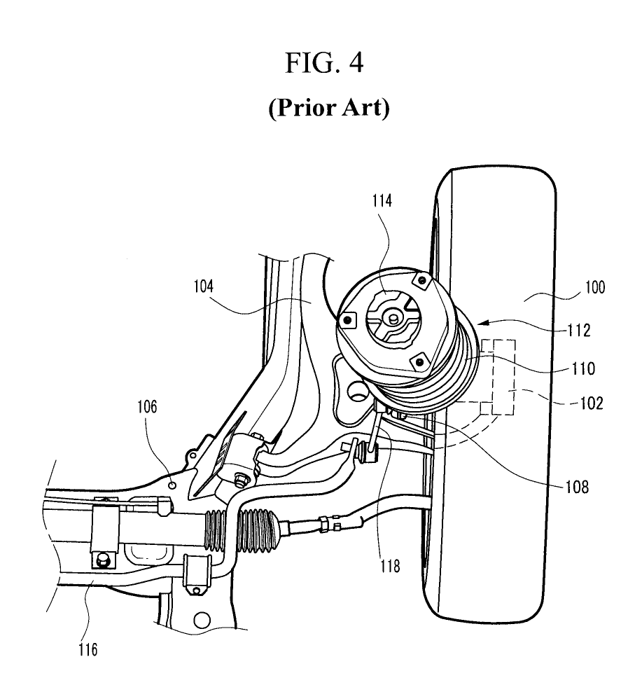

FIG. 5 is a top plan view of a conventional lower arm assembly.

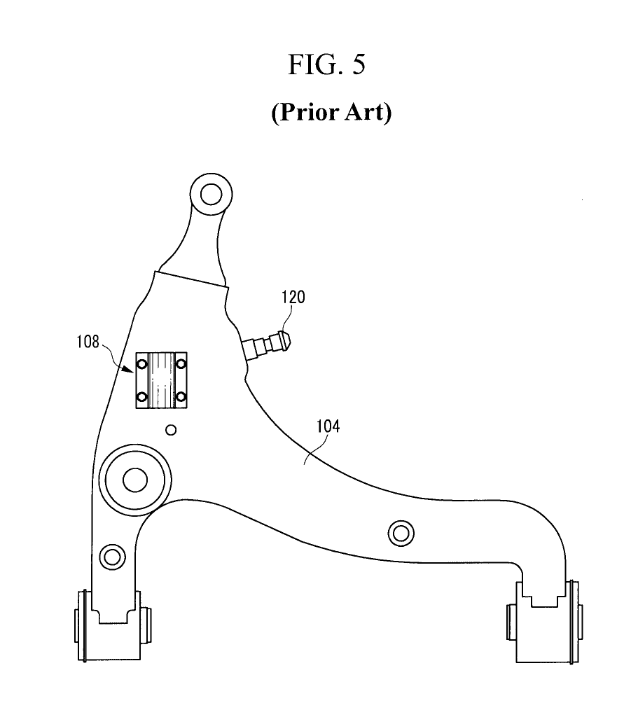

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

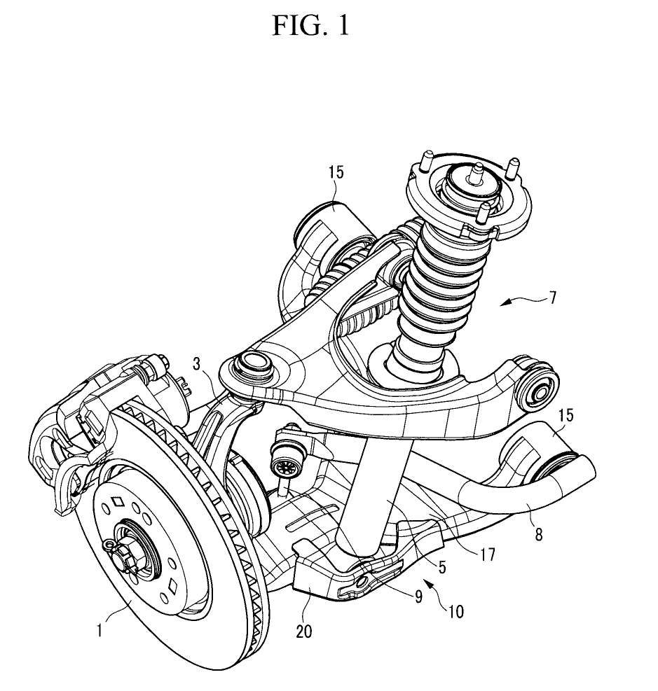

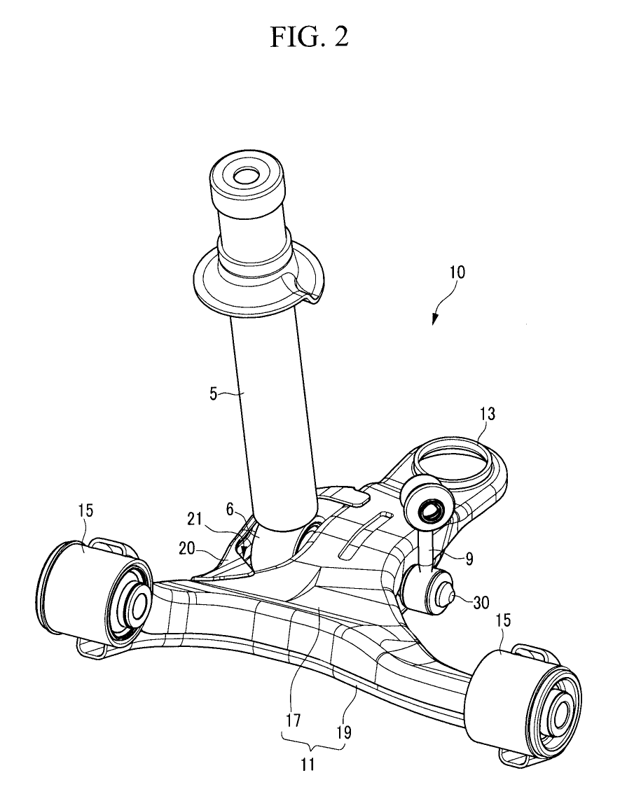

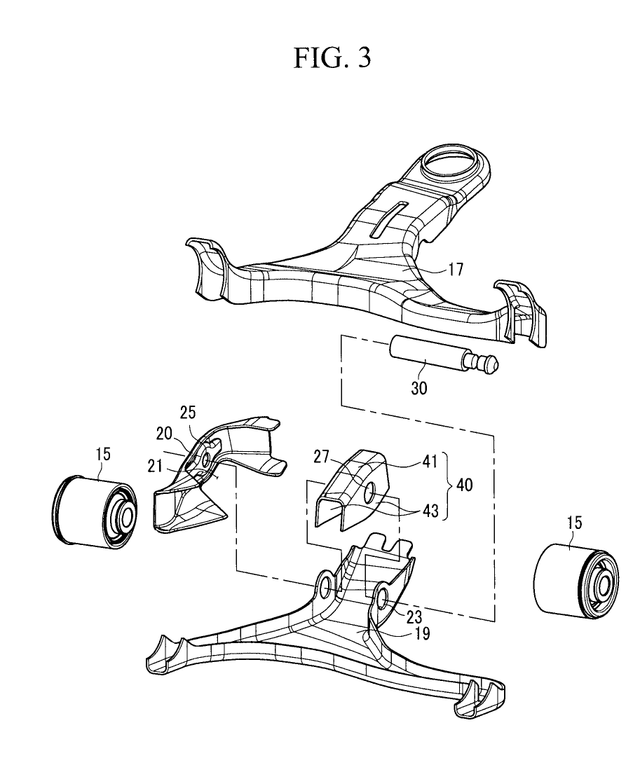

FIG. 1 is a perspective view including a lower arm assembly for a suspension system according to various embodiments of the present invention, FIG. 2 is a perspective view of a lower arm assembly for a suspension system according to various embodiments of the present invention, and FIG. 3 is an exploded perspective view of a lower arm assembly according to various embodiments of the present invention.

A lower arm assembly 10 for a suspension system according to various embodiments of the present invention, as shown in FIG. 1, includes a knuckle 3, which rotatably supports a disk 1, and a strut assembly 7, which is integrally formed by a coil spring and a shock absorber 5.

An upper portion of the strut assembly 7 is supported by a vehicle body through interposing an insulator, and a lower portion of the knuckle 3 is connected with the lower arm assembly 10.

The lower arm assembly 10 according to various embodiments of the present invention, as shown in FIG. 2 and in FIG. 3, includes a lower arm member 11, a shock absorber mounting portion 20, and a stabilizer bar mounting rod 30.

The shock absorber 5 and a stabilizer bar 8 are mounted to the lower arm member 11 through the stabilizer bar mounting rod 30.

A connecting portion 13 is formed to an end of the lower arm member 11 for connecting the lower portion of the knuckle 3, and a bushing 15 is mounted to other ends of the lower arm member 11 for connecting with a vehicle body.

The lower arm member 11 includes upper and lower arm plates 17 and 19, and the upper and lower arm plates 17 and 19 are connected with each other.

The shock absorber mounting portion 20 is mounted to the lower arm member 11, and preferably the shock absorber mounting portion 20 is integrally formed.

Between the shock absorber mounting portion 20 and the lower arm member 11, a receiving hole 21 is formed and a shock absorber connector 6 of the shock absorber 5 is inserted therein.

A first mounting rod hole 23 is formed to the lower arm member 11, and the stabilizer bar mounting rod 30 is disposed to be inserted into the first mounting rod hole 23.

In various embodiments of the present invention, a second mounting rod hole 25 may be formed to the shock absorber mounting portion 20, and an end of the stabilizer bar mounting rod 30 is connected to the second mounting rod hole 25.

The lower portion of the shock absorber 5 is inserted into the receiving hole 21, and the stabilizer bar mounting rod 30 that is protruded to the receiving hole 21 is connected with the shock absorber connector 6.

A connecting link 9 is mounted to another end of the stabilizer bar mounting rod 30 for connecting the stabilizer bar 8.

Accordingly, the stabilizer bar mounting rod 30 is penetrated through the lower arm member 11 in a traverse direction and supported by the lower arm member 11 and thus the connecting link 9 and the shock absorber 5 are linked by the stabilizer bar mounting rod 30.

The lower arm assembly 10 further includes a supporting member 40 that includes a contact portion 4 1, and a supporting portion 43 supporting the contact portion 41.

In various embodiments of the present invention, a supporting member 40 may be disposed within the lower arm member 11, a third mounting rod hole 27 is formed thereto, and the stabilizer bar mounting rod 30 is inserted through the third mounting rod hole 27.

The supporting portion 43 and the contact portion 41 respectively support an interior surface of the lower arm member 1 so that rigidity of the lower arm member 11 can be enhanced.

Thus, as described above, in the lower arm assembly 10 for a suspension system according to various embodiments of the present invention, the shock absorber mounting portion 20 is disposed to a lateral side of the lower arm member 11, the stabilizer bar mounting rod 30 is disposed to penetrate the lower arm member 11 in a traverse direction thereof, and the shock absorber 5 and stabilizer bar 8 are coupled to the shock absorber mounting portion 20 and the stabilizer bar mounting rod 30 so that total rigidity of the lower arm assembly 10 can be enhanced.

A mounting bracket and a mounting pin and so on for mounting the shock absorber 5 and the stabilizer bar 8 are not needed, so size and weight of the lower arm assembly 10 can be reduced.

For convenience in explanation and accurate definition in the appended claims, the terms “upper” and “lower” are used to describe features of the various embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various embodiments of the present invention, as well as various alternatives and modifications thereof. It is intended that the scope of the invention be defined by the Claims appended hereto and their equivalents.

What is claimed is:

1. A lower arm assembly for a suspension system, comprising:
a lower arm member; and
a stabilizer bar mounting rod supported by the lower arm member, wherein one end portion of the stabilizer bar mounting rod is pivotally coupled to a shock absorber and the other end thereof is fixedly connected to a connecting link.

2. The lower arm assembly of claim 2, wherein the lower arm member includes a first mounting rod hole to receive the stabilizer bar mounting rod in a traverse direction of the lower arm member therethrough.

3. The lower arm assembly of claim 1, wherein a shock absorber mounting portion is coupled to one lateral side of the lower arm member and mounts the one end portion of the shock absorber between the lower arm member and the shock absorber mounting portion.

4. The lower arm assembly of claim 3, wherein a second mounting hole is formed to the shock absorber mounting portion to receive the one end portion of the stabilizer bar mounting rod.

5. The lower arm assembly of claim 3, wherein the shock absorber mounting portion is monolithically formed to the lower arm member.

6. The lower arm assembly of claim 3, wherein a receiving hole is formed between the shock absorber mounting portion and the lower arm member for receiving a lower portion of the shock absorber therein.

7. The lower arm assembly of claim 6, wherein the lower portion of the shock absorber includes a shock absorber connector to pivotally support the shock absorber.

8. The lower arm assembly of claim 1, wherein the connecting link is mounted onto the other lateral side of the lower arm member.

9. The lower arm assembly of claim 1, further comprising a supporting member that is disposed within the lower arm member and includes a contact portion and a supporting portion, wherein the contact portion supports an inner upper surface of the lower arm member and the supporting portion is supported by an inner lower surface of the lower arm member.

10. The lower arm assembly of claim 9, wherein a third mounting rod hole is formed to the supporting member and the stabilizer bar mounting rod is inserted into the third mounting rod hole.

11. The lower arm assembly of claim 1, wherein the lower arm member comprises an upper arm plate and a lower arm plate that is integrally connected with the upper arm plate.

12. The lower arm assembly of claim 11, further comprising a supporting member that is disposed within the lower arm member and includes a contact portion and a supporting portion, wherein the contact portion supports the upper arm plate and the supporting portion is supported by the lower arm plate.

13. A passenger vehicle comprising the lower arm assembly of claim 1.
